(19) United States
(12) Patent Application Publication
(10) Pub. No.: US 2025/0242674 A1
(43) Pub. Date: Jul. 31, 2025

(54) Windshield Protector Device

(71) Applicant: William Irvin, Denver, CO (US)

(72) Inventor: William Irvin, Denver, CO (US)

(21) Appl. No.: 18/885,981

(22) Filed: Sep. 16, 2024

Related U.S. Application Data
(60) Provisional application No. 63/626,674, filed on Jan. 30, 2024.

(51) Int. Cl. B60J 11/08; B60J 3/02

(52) U.S. Cl. CPC B60J 11/08; B60J 3/0286

(57) ABSTRACT

A windshield protector device is provided. The device is comprised of a protective device for vehicle windshields, comprising a flexible, shatterproof body that can adapt to various windshield shapes and sizes. The body is designed to cover and protect windshields from debris and may feature a tint for UV/sun protection. In one embodiment, the front surface of the body is comprised of a removable polyurethane film layer to protect against impacts, which can be replaced as needed. Additionally, the rear surface may be comprised of an adhesive in one embodiment to securely attach the device to a vehicle windshield.

### CROSS-REFERENCE TO RELATED APPLICATION

The present application claims priority to, and the benefit of, U.S. Provisional Application No. 63/626,674, which was filed on Jan. 30, 2024, and is incorporated herein by reference in its entirety.

### FIELD OF THE INVENTION

The present invention relates generally to the field of windshield protection devices. More specifically, the present invention relates to a windshield protector device that provides an easily removable, adhesively attached, impact-protective device that can be secured to the exterior of a vehicle windshield. Accordingly, the present disclosure makes specific reference thereto. Nonetheless, it is to be appreciated that aspects of the present invention are also equally applicable to other like applications, devices, and methods of manufacture.

### BACKGROUND

Rocks, debris, and other common hazards encountered on the road pose significant risks to vehicles, particularly when it comes to the integrity and safety of windshields. Small stones, pieces of glass, and various forms of road detritus can be propelled at high speeds toward vehicles, especially when traveling at highway speeds or in areas of construction. This can result in cracks, chips, and other forms of damage to windshields. For large vehicles such as trucks, buses, and commercial vehicles, the impact of such damage is not only a matter of repair costs but also operational concerns. The process of windshield replacement in these larger vehicles is not only costly due to the size and specialized nature of the glass required but also because it can lead to significant downtime. This downtime is often unwanted and can disrupt schedules, lead to missed deliveries, or impact the provision of services, highlighting the importance of maintaining vehicle windshields and promptly addressing any damage to minimize costs and operational disruptions.

Therefore, there exists a long-felt need in the art for a device for protecting windshields. There also exists a long-felt need in the art for a windshield protector device that protects windshields against impacts and cracks. In addition, there exists a long-felt need in the art for a windshield protector device that protects windshields against impacts and cracks wherein the device can be easily replaced as needed.

The subject matter disclosed and claimed herein, in one embodiment thereof, comprises a windshield protector device. The device is comprised of a protective device for vehicle windshields, comprising a flexible, shatterproof body that can adapt to various windshield shapes and sizes. The body is designed to cover and protect windshields from debris and may feature a tint for UV/sun protection. In one embodiment, the front surface of the body is comprised of a removable polyurethane film layer to protect against impacts, which can be replaced as needed. Additionally, the rear surface may be comprised of an adhesive in one embodiment to securely attach the device to a vehicle windshield.

In this manner, the windshield protector device of the present invention accomplishes all the forgoing objectives and provides a device for protecting windshields. More specifically, the device protects windshields against impacts and cracks. While doing so, the device can be easily replaced as needed.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a windshield protector device comprised of a body that covers and protects a windshield of any vehicle type. The body is preferably made from a flexible, shatterproof Plexiglas material. In one embodiment, the body may be tinted with any color to provide UV/sun protection.

In one embodiment, the front surface of the body is comprised of at least one layer of removable film that protects the front surface during use. If the front surface is impacted by debris while driving, the film can be removed and a new layer of film can be applied to the front surface.

The rear surface of the body may be comprised of at least one adhesive that allows the rear surface to attach to the exterior surface of a vehicle windshield. In a different embodiment, the adhesive is spread onto the windshield and thus secures the rear surface to the windshield once the device has been applied to a windshield.

The present invention is also comprised of a method of using the device. First, a device is provided comprised of a body comprised of a rear surface comprised of an adhesive. Then, the rear surface can be adhered to an exterior surface of a vehicle windshield via the adhesive. In a further embodiment, a front surface of the body is comprised of a film, wherein the film can be removed from the front surface and replaced with a new film once the existing film becomes damaged.

The present invention is also comprised of a second method of using the device. First, a device is provided comprised of a body comprised of a front surface and rear surface. Then, the rear surface can be adhered to an exterior surface of a vehicle windshield by spreading an adhesive onto the exterior surface and placing the rear surface on the exterior surface. In a further embodiment, a front surface of the body is comprised of a film, wherein the film can be removed from the front surface and replaced with a new film once the existing film becomes damaged.

Accordingly, the windshield protector device of the present invention is particularly advantageous as it provides a device for protecting windshields. More specifically, the device protects windshields against impacts and cracks. While doing so, the device can be easily replaced as needed. In this manner, the windshield protector device provides a solution to easily protect the windshields of large vehicles.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view and a rear view of one potential embodiment of a windshield protector device of the present invention in accordance with the disclosed architecture;

FIG. 2 illustrates a side view of two potential embodiments of a windshield protector device of the present invention in accordance with the disclosed architecture

FIG. 3 illustrates a flowchart of a method of using one potential embodiment of a windshield protector device of the present invention in accordance with the disclosed architecture; and

FIG. 4 illustrates a flowchart of a method of using one potential embodiment of a windshield protector device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for protecting windshields. There also exists a long-felt need in the art for a windshield protector device that protects windshields against impacts and cracks. In addition, there exists a long-felt need in the art for a windshield protector device that protects windshields against impacts and cracks wherein the device can be easily replaced as needed.

The present invention, in one exemplary embodiment, is comprised of a windshield protector device with a body that covers and protects a windshield of any vehicle type. The body is preferably made from a flexible, shatterproof Plexiglas material. In one embodiment, the body may be tinted with any color to provide UV/sun protection.

In one embodiment, the front surface of the body is comprised of at least one layer of removable film that protects the front surface during use. If the front surface is impacted by debris while driving, the film can be removed and a new layer of film can be applied to the front surface.

The rear surface of the body may be comprised of at least one adhesive that allows the rear surface to attach to the exterior surface of a vehicle windshield. In a different embodiment, the adhesive is spread onto the windshield and thus secures the rear surface to the windshield once the device has been applied to a windshield.

The present invention is also comprised of a method of using the device. First, a device is provided comprised of a body comprised of a rear surface comprised of an adhesive. Then, the rear surface can be adhered to an exterior surface of a vehicle windshield via the adhesive. In a further embodiment, a front surface of the body is comprised of a film, wherein the film can be removed from the front surface and replaced with a new film once the existing film becomes damaged.

The present invention is also comprised of a second method of using the device. First, a device is provided comprised of a body comprised of a front surface and rear surface. Then, the rear surface can be adhered to an exterior surface of a vehicle windshield by spreading an adhesive onto the exterior surface and placing the rear surface on the exterior surface. In a further embodiment, a front surface of the body is comprised of a film, wherein the film can be removed from the front surface and replaced with a new film once the existing film becomes damaged.

Accordingly, the windshield protector device of the present invention is particularly advantageous as it provides a device for protecting windshields. More specifically, the device protects windshields against impacts and cracks. While doing so, the device can be easily replaced as needed. In this manner, the windshield protector device provides a solution to easily protect the windshields of large vehicles.

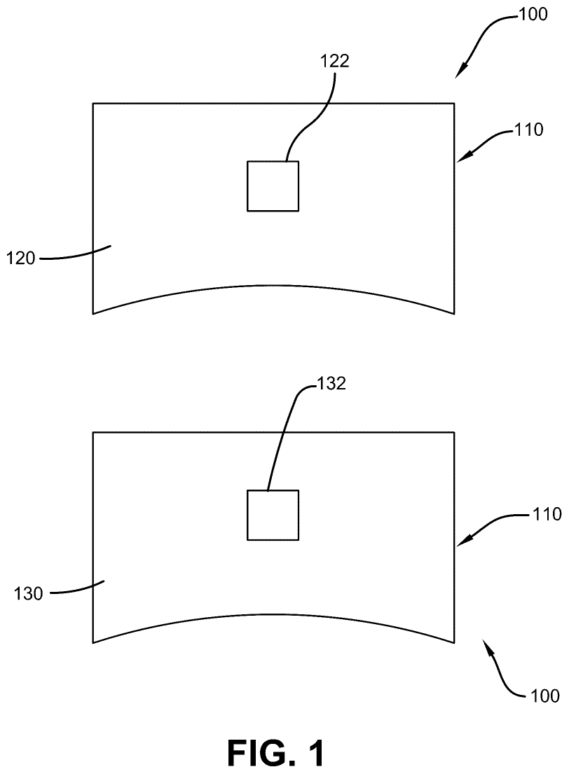

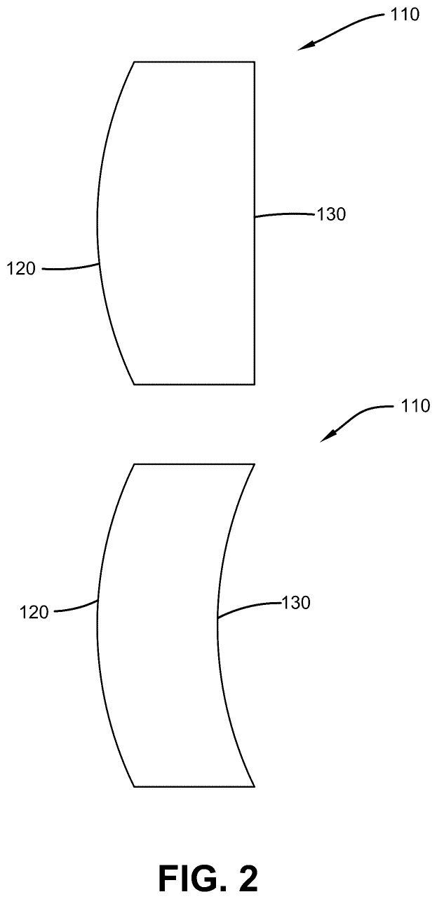

Referring initially to the drawings, FIG. 1 illustrates a front view and a rear view of one potential embodiment of a windshield protector device 100 of the present invention in accordance with the disclosed architecture. The device 100 is comprised of a body 110. The body 110 may be any size, shape, and configuration that allows the body 110 to cover and protect a windshield of any vehicle type. The body 110 may be flat in one embodiment. In another embodiment, the body 110 may have a curved front surface 120 and/or rear surface 130 to match the curvature of a windshield the device 100 is applied to, as seen in FIG. 2.

The body 110 is preferably made from a flexible, shatterproof Plexiglas material. However, the body 110 may be made from a plurality of materials such as but not limited to a polycarbonate, an acrylic, a tempered glass, a thermoplastic polyurethane, a glass-reinforced plastic, etc. In one embodiment, the body 110 may be tinted with any color to provide UV/sun protection. The tint may be any tint percentage known in the art.

In one embodiment, the front surface 120 of the body 110 is comprised of at least one layer of removable film 122. The film 122 protects the front surface 120 during use. If the front surface 120 is impacted by debris while driving, the film 122 can be removed and a new layer of film 122 can be applied to the front surface. The film 122 is preferably but not limited to a polyurethane film.

The rear surface 130 of the body 110 may be comprised of at least one adhesive 132 that allows the rear surface 130 to attach to the exterior surface of a vehicle windshield. In a different embodiment, the adhesive 132 is spread onto the windshield and thus secures the rear surface 130 to the windshield once the device 100 has been applied to a windshield. The adhesive 132 may include but is not limited to a pressure-sensitive adhesive, a silicone adhesive, an acrylic adhesive, a urethane adhesive, an epoxy adhesive, an adhesive tape, etc.

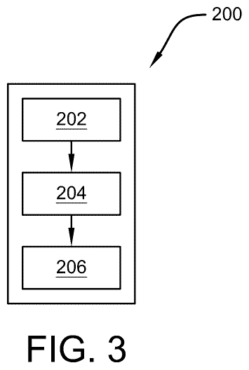

The present invention is also comprised of a method of using 200 the device 100, as seen in FIG. 3. First, a device 100 is provided comprised of a body 110 comprised of a rear surface 130 comprised of an adhesive 132 [Step 202]. Then, the rear surface 130 can be adhered to an exterior surface of a vehicle windshield via the adhesive 132 [Step 204]. In a further embodiment, a front surface 120 of the body 110 is comprised of a film 122, wherein the film 122 can be removed from the front surface 120 and replaced with a new film 122 once the existing film 122 becomes damaged [Step 206].

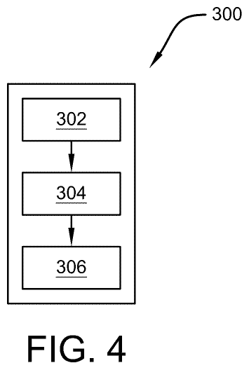

The present invention is also comprised of a second method of using 300 the device 100, as seen in FIG. 4. First, a device 100 is provided comprised of a body 110 comprised of a front surface 120 and rear surface 130 [Step 302]. Then, the rear surface 130 can be adhered to an exterior surface of a vehicle windshield by spreading an adhesive 132 onto the exterior surface and placing the rear surface 130 on the exterior surface [Step 304]. In a further embodiment, a front surface 120 of the body 110 is comprised of a film 122, wherein the film 122 can be removed from the front surface 120 and replaced with a new film 122 once the existing film 122 becomes damaged [Step 306].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “windshield protector device” and “device” are interchangeable and refer to the windshield protector device 100 of the present invention.

Notwithstanding the forgoing, the windshield protector device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the windshield protector device 100 as shown in the FIGS. are for illustrative purposes only, and that many other sizes and shapes of the windshield protector device 100 are well within the scope of the present disclosure. Although the dimensions of the windshield protector device 100 are important design parameters for user convenience, the windshield protector device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A windshield protector device comprising:
a body comprised of a front surface and a rear surface; and
an adhesive.

2. The windshield protector device of claim 1, wherein the body is comprised of a flexible material.

3. The windshield protector device of claim 2, wherein the body is comprised of a Plexiglas, a polycarbonate, an acrylic, a tempered glass, a thermoplastic polyurethane, or a glass-reinforced plastic.

4. The windshield protector device of claim 3, wherein the body is comprised of a colored tint

5. The windshield protector device of claim 1, wherein the adhesive is comprised of a pressure-sensitive adhesive, a silicone adhesive, an acrylic adhesive, a urethane adhesive, an epoxy adhesive, or an adhesive tape.

6. The windshield protector device of claim 1, wherein the body is comprised of a curved front surface.

7. The windshield protector device of claim 1, wherein the body is comprised of a curved rear surface.

8. A windshield protector device comprising:
a body comprised of a front surface comprised of a film and a rear surface comprised of an adhesive.

9. The windshield protector device of claim 8, wherein the film is comprised of a polyurethane film.

10. The windshield protector device of claim 8, wherein the body is comprised of a flexible material.

11. The windshield protector device of claim 10, wherein the body is comprised of a Plexiglas, a polycarbonate, an acrylic, a tempered glass, a thermoplastic polyurethane, or a glass-reinforced plastic.

12. The windshield protector device of claim 11, wherein the body is comprised of a colored tint.

13. The windshield protector device of claim 8, wherein the adhesive is comprised of a pressure-sensitive adhesive, a silicone adhesive, an acrylic adhesive, a urethane adhesive, an epoxy adhesive, or an adhesive tape.

14. The windshield protector device of claim 8, wherein the body is comprised of a curved front surface.

15. The windshield protector device of claim 8, wherein the body is comprised of a curved rear surface.

16. A method of using a windshield protector device, the method comprising the following steps:
providing a windshield protector device comprised of a body comprised of a front surface and a rear surface; and
adhering the rear surface to an exterior of a vehicle windshield via an adhesive.

17. The method of using a windshield protector device of claim 16, wherein the adhesive is comprised of a pressure-sensitive adhesive, a silicone adhesive, an acrylic adhesive, a urethane adhesive, an epoxy adhesive, or an adhesive tape.

18. The method of using a windshield protector device of claim 16, wherein the body is comprised of a flexible material.

19. The method of using a windshield protector device of claim 18, wherein the body is comprised of a Plexiglas, a polycarbonate, an acrylic, a tempered glass, a thermoplastic polyurethane, or a glass-reinforced plastic.

20. The method of using a windshield protector device of claim 16, wherein the body is comprised of a colored tint.
